(19) United States
(12) Patent Application Publication
(10) Pub. No.: US 2017/0202201 A1
(43) Pub. Date: Jul. 20, 2017

(54) Hand-Held Pest Exterminating Device

(71) Applicant: Jonathan Barraclough, Tehachapi, CA (US)

(72) Inventor: Jonathan Barraclough, Tehachapi, CA (US)

(21) Appl. No.: 14/995,236

(22) Filed: Jan. 14, 2016

(51) Int. Cl. A01M 3/02

(52) U.S. Cl. CPC A01M 3/025

(57) ABSTRACT

A hand-held pest exterminating device for use in eliminating flying or crawling insects. The pest exterminating device includes a pair of parallel supports having a plurality of electrified wires extending therebetween. The supports are tubular and include one or more lights therein so as to illuminate the supports. The pair of parallel supports are arranged on a lower guard, wherein the lower guard further includes a handle extending therefrom for a user to grasp. The lower guard and handle enclose a control circuit including a power source that provides electricity to the lights and to the wires. Further, an audio unit is provided, wherein the audio unit is adapted to produce a sound effect as the device is moved about and when an insect is exterminated.

### BACKGROUND OF THE INVENTION

Field of the Invention

The present invention relates to pest control devices. More specifically, the present invention provides a hand-held pest exterminating device for use in killing crawling or flying insects.

Crawling and flying insects are a nuisance and can disrupt an outdoor gathering. This is particularly true in areas having a warm or humid climate. In such areas, mosquitoes, horse flies, gnats, and other insects are commonly encountered when spending time outdoors. In addition to causing a disturbance, various types of insects carry germs or disease and can contaminate food or beverages. Further, many insects bite or sting, which can irritate the skin and may cause pain.

Multiple existing devices are available for warding off pests, such as citronella candles, electrified bug zappers, fly swatters, and fly paper strips, among various other devices. However, such devices are passive devices, and do not allow a person to actively exterminate a bug that is creating a nuisance. While fly swatters can be used to actively pursue and kill an insect, fly swatters are difficult to use and cannot be used while the insect is flying. Instead, the user must wait until the insect lands on a surface. Thus, a device for allowing a user to actively exterminate disruptive bugs and pests is desired.

### SUMMARY OF THE INVENTION

In view of the disadvantages inherent in the known types of pest control devices now present in the prior art, the present invention provides a new pest control device wherein the same can be utilized for providing convenience for the user when exterminating flying or crawling insects while providing entertainment for the user.

A hand-held insect exterminating device is provided. The exterminating device comprises a pair of elongated supports having a plurality of electrified wires extending therebetween. The supports are tubular members that include one or more lights therein so as to illuminate the supports. The illuminated supports are mounted on a lower guard having a handle thereon. In this way, the user can hold the handle and can move the device so that the electrified wires contact a flying or crawling insect. The handle may further include an audio unit therein, wherein the audio unit is adapted to produce sound effects as the device is moved about and when an insect is exterminated.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of the hand-held pest exterminating device.

FIG. 2 shows a schematic diagram of the control circuit of the hand-held pest exterminating device.

### DETAILED DESCRIPTION OF THE INVENTION

Reference is made herein to the attached drawings. Like reference numerals are used throughout the drawings to depict like or similar elements of the hand-held pest exterminating device. For the purposes of presenting a brief and clear description of the present invention, the preferred embodiment will be discussed as used for killing flying and crawling insects while providing entertainment for the user. The figures are intended for representative purposes only and should not be considered to be limiting in any respect.

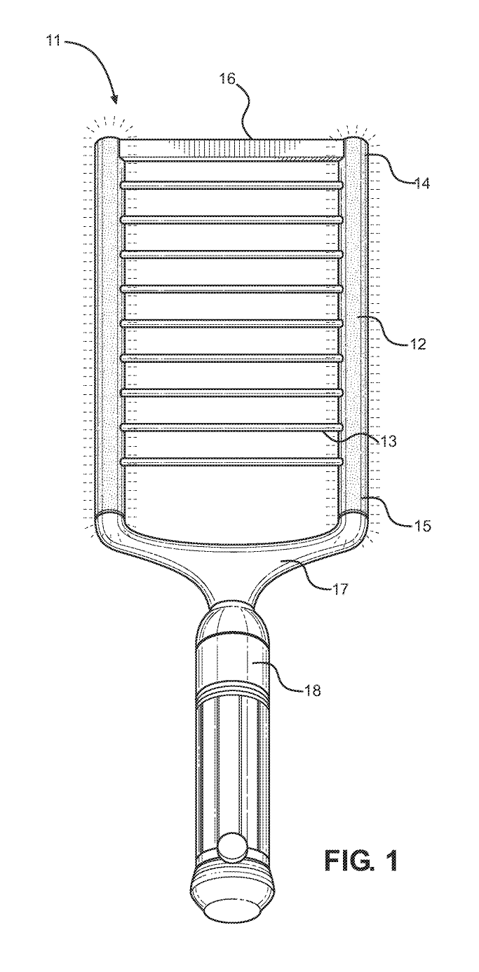

Referring now to FIG. 1, there is shown a frontal view of the hand-held pest exterminating device. The hand-held pest exterminating device 11 comprises a pair of illuminated supports 12 that are substantially parallel to one another. The illuminated supports 12 comprise tubular members having a hollow interior volume in which one or more lights are positioned. The supports 12 are preferably composed of a translucent material so that the lights therein cause the supports 12 produce a uniform glow. The lights are preferably LED lights, however, other light sources can be used in alternate embodiments.

A plurality of electrified wires 13 extend between the pair of illuminated supports 12. In the illustrated embodiment, the electrified wires 13 are parallel to one another and are spaced at a fixed interval. Further, the electrified wires 13 are substantially perpendicular to the supports 12. The electrified wires 13 are adapted to kill any crawling or flying insects that come into contact therewith. In alternate embodiments, the electrified wires 13 comprise a grid pattern or any other suitable configuration extending between the pair of illuminated supports 12.

The supports 12 further include an upper end 14 and a lower end 15. The upper end 14 includes an upper guard 16 that extends between the supports 12. The upper guard 16 is preferably composed of rubber, plastic, or another electrically insulating material so that the guard 16 does not have an electric charge. The upper guard 16 helps to prevent a user or third party from contacting the electrified wires at the upper end 14 of the device 11. Further, the upper guard 16 helps to provide the device with improved strength and durability.

The lower end 15 of the supports 12 is connected to a lower guard 17. A handle 18 is further secured to the lower guard 17 and can be grasped by the user in order to maneuver the device 11. The handle 18 is adapted to be grasped by a single hand and includes padding or cushioning in some embodiments so as to provide a comfortable grip for the user. The handle 18 and lower guard 17 are composed of an electrically insulated or non-conducting material so that electrical current does not flow therethrough.

The handle 18 and lower guard 17 further enclose the control circuit of the exterminating device 11. The control circuit comprises a power source for illuminating the lights and for electrifying the wires 13 for use in killing insects. Additional electrical components are used to provide safety and durability. However, it is not desired to limit the present invention to a specific electrical circuit used to electrify the wires 13.

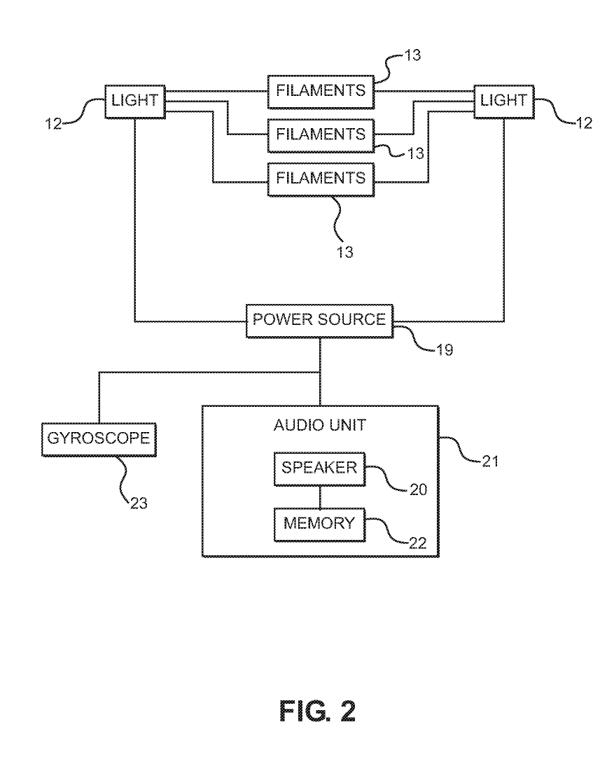

Referring now to FIG. 2, there is shown a schematic diagram of the control circuit of the hand-held pest exterminating device. The control circuit comprises a power source 19 for providing electricity to the lights 12 and wires 13 of the exterminating device 11. The power source 19 is preferably one or more rechargeable batteries. A power control is further provided to allow the user to turn the device on or off.

In some embodiments, the exterminating device 11 further comprises an audio unit 21 adapted to produce sound effects when the exterminating device 11 is moved or swung. The audio unit 21 comprises a memory 22 adapted to store one or more sound effects, and further comprises a speaker 20 through which the pre-recorded sound effects are played. A gyroscope 23 or other sensor for detecting motion of the exterminating device 11 is provided. When the gyroscope 23 detects that the exterminating device 11 is being moved or swung, the audio unit 21 is adapted to play a pre-recorded sound.

Further, the exterminating device 11 is adapted to produce a sound effect when an insect is exterminated by coming into contact with the electrified wires. When an insect contacts the wires, there will be a momentary drop in voltage due to the increased resistance provided by the insect, and when the voltage drop is detected, the audio unit 21 is adapted to produce a sound effect. However, other means for detecting than an insect has been exterminated can be used in accordance with the present invention. In this way, the exterminating device 11 provides additional entertainment for the user and may encourage the user to continue to utilize the exterminating device 11.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hand-held exterminating device, comprising:
a pair of supports disposed on a lower guard;
a plurality of electrified wires extending between the pair of supports, wherein the electrified wires are adapted to kill an insect that comes into contact therewith;
a handle extending from the lower guard;
a control circuit comprising a power source adapted to provide electricity to the electrified wires.

2) The hand-held exterminating device of claim 1, wherein the pair of supports are illuminated.

3) The hand-held exterminating device of claim 2, wherein each support of the pair of supports comprises a hollow interior volume with one or more lights therein.

4) The hand-held exterminating device of claim 1, wherein the plurality of electrified wires are substantially parallel to one another.

5) The hand-held exterminating device of claim 1, further comprising an upper guard extending between the pair of supports at an upper end of the pair of supports.

6) The hand-held exterminating device of claim 1, further comprising an audio unit adapted to produce a sound effect when the handle is moved about.

7) The hand-held exterminated device of claim 1, further comprising an audio unit adapted to produce a sound effect when an insect contacts one of the plurality of electrified wires.

8) The hand-held exterminating device of claim 7, wherein the audio unit comprises a speaker and a memory on which pre-recorded sound effects are stored.

9) The hand-held exterminating device of claim 6, wherein the audio unit comprises a gyroscope adapted to determine if the handle is in motion.
